(19) United States
(12) Patent Application Publication
(10) Pub. No.: US 2018/0343843 A1
(43) Pub. Date: Dec. 6, 2018

(54) Controlled Sinking Weight

(71) Applicant: Sabrina Butler, Rochester, MI (US)

(72) Inventor: Sabrina Butler, Rochester, MI (US)

(21) Appl. No.: 15/992,348

(22) Filed: May 30, 2018

Related U.S. Application Data
(60) Provisional application No. 62/513,725, filed on Jun. 1, 2017.

(51) Int. Cl. A01K 95/00

(52) U.S. Cl. CPC A01K 95/00

(57) ABSTRACT

A slip sinker includes an elongated inner tubular weighted mass having a conical end for ease of threading a fishing line. Annularly disposed about the elongated inner tubular weighted mass is a casing shell that provides a level of buoyancy and which has a generally bulged, symmetrical, and cylindrical or oblong shape. The casing shell is a durable, buoyant, low-density element. The slip sinker has a shape and density which causes the sinker to be slow to sink, to land softly, to make less noise, and to avoid digging into bottom substrates. The disclosed slip sinker: does not easily tangle in weeds or other bottom substrates; starts to ascend immediately upon the line being tugged or reeled, such as to avoid dragging across the bottom of the body of water and/or catching on obstacles; and improves ease of casting, such as by allowing for improved control and farther casts.

### CROSS-REFERENCE TO RELATED APPLICATION(S)

This disclosure claims priority to and the benefit of U.S. Provisional Application Patent Ser. No. 62/513,725, filed Jun. 1, 2017, the entire disclosure of which is hereby incorporated by reference.

### TECHNICAL FIELD

This disclosure relates to a controlled sinking weight for fishing, and, more particularly, to a slip sinker having improved sinking, rising, and casting functionality.

### BACKGROUND

The pursuit of fish has always been a challenge. Of particular note is the equipment which is widely available in many configurations. This hardware suffers from several problems. These include weighted sinkers which descend too quickly to the bottom of a body of water, dig themselves into the bottom substrate (e.g., weeds), make noise when hitting the bottom of the body of water, tangle in weeds, and more. These problems may result in the loss of the sinker, such as by decoupling from the remaining hardware, of the entire rig, and/or loss of the pursued fish. Additionally, users are often unable to cast far enough. In that casting distance is a typical desire of a fisherman, a typical weighted sinker may be insufficient.

### SUMMARY

Disclosed herein are embodiments of a slip sinker. In one embodiment, a slip sinker comprises a casing shell and an elongated inner tubular weighted mass. The casing shell is comprised of a buoyant material and features a circumferential bulge at a central portion along an axial plane. The elongated inner tubular weighted mass is annularly disposed within the casing shell and includes an opening configured to slidably receive a fishing line. A first end of the elongated inner tubular weighted mass is generally concave relative to a first end of the casing shell and a second end of the elongated inner tubular weighted mass is generally convex relative to a second end of the casing shell. The circumferential bulge is defined by a symmetrical and gradual radial increase of a cross-section of the casing shell between the central portion of the casing shell and each of the first end of the casing shell and the second end of the casing shell.

In another embodiment, a slip sinker comprises a casing shell and an elongated inner tubular weighted mass. The casing shell is comprised of a buoyant material and features a circumferential bulge at a central portion along an axial plane. The elongated inner tubular weighted mass is annularly disposed within the casing shell and includes an opening configured to slidably receive a fishing line. The buoyant material of the casing shell causes a slowed sinking rate and an accelerated rising rate for the slip sinker.

In yet another embodiment, a slip sinker comprises a casing shell and an elongated inner tubular weighted mass. The casing shell is comprised of a buoyant material and features a circumferential bulge at a central portion along an axial plane. The elongated inner tubular weighted mass is annularly disposed within the casing shell and includes an opening that slidably receives a fishing line between a first end of the fishing line and a second end of the fishing line. A first end of the elongated inner tubular weighted mass is generally concave relative to a first end of the casing shell and a second end of the elongated inner tubular weighted mass is generally convex relative to a second end of the casing shell. The slidable receipt of the fishing line within the opening of the elongated inner tubular weighted mass causes the slip sinker to slidably move along the fishing line between the first end of the fishing line and the second end of the fishing line during use. The circumferential bulge is defined by a symmetrical and gradual radial increase of a cross-section of the casing shell between the central portion of the casing shell and each of the first end of the casing shell and the second end of the casing shell. The buoyant material of the casing shell causes a slowed sinking rate and an accelerated rising rate for the slip sinker. An exterior surface of the casing shell is smooth, wherein the smooth exterior surface and the gradual radial increase of the casing shell mitigate obstructions from catching the slip sinker during use.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-C are illustrations showing examples of the use of a slip sinker.

FIG. 2 is an illustration of showing a first example view of the referenced slip sinker.

FIG. 3 is an illustration of showing a second example view of the referenced slip sinker.

FIG. 4 is an illustration of showing a third example view of the referenced slip sinker.

FIGS. 5A-C are illustrations showing examples of internal structures of the referenced slip sinker.

### DETAILED DESCRIPTION

A slip sinker according to the embodiments of this disclosure has an elongated inner tubular weighted mass configured to slidably receive a fishing line and to more easily receive the fishing line, such as compared to a typical slip sinker. The line moves freely through the elongated inner tubular weighted mass to minimize the chances of spooking a fish when it bites. That is, the structure of the elongated inner tubular weighted mass within the slip sinker reduces or eliminates resistance and restriction for the fish when nibbling or biting the hooked bait. This also reduces the possibility of the line breaking, if the fish jerks on the line, and the fish ultimately being lost. The elongated inner tubular weighted mass also allows for longer, more precise casting.

The slip sinker according to the embodiments of this disclosure also has a casing shell annularly disposed about the elongated inner tubular weighted mass. The casing shell is comprised of a buoyant material, which may have a low-density, such as relative to the elongated inner tubular weighted mass. The physical properties of the buoyant material of the casing shell cause a slowed sinking rate and an accelerated rising rate for the slip sinker. The buoyant material of the casing shell may be comprised of one or more naturally occurring materials, one or more synthetic materials, or a combination thereof. Examples of naturally occurring materials comprising the case shell include, without limitation, bamboo, wood, or the like. Examples of synthetic materials comprising the casing shell include, without limitation, foam, Styrofoam, ethylene-vinyl acetate, expanded polystyrene, or the like.

The elongated inner tubular weighted mass is comprised of a high-density material, such as a material having a higher density relative to the casing shell. For example, the high-density material comprising the elongated inner tubular weighted mass may be a metal, such as lead, tungsten, or the like, or a combination thereof. The elongated inner tubular weighted mass is a single weighted component. The casing shell is a single component separate from, but which is coupled to, the elongated inner tubular weighted mass. Alternatively, the cashing shell and the elongated inner tubular weighted mass may represent elements of a single component. The casing shell may be very durable and resistant to breakage, damage, and/or discoloration.

The casing shell may be annularly disposed about the elongated inner tubular weighted mass by way of a compression fit (e.g., of the weight of the elongated inner tubular weighted mass inside of the soft material of the casing shell), an adhesive (e.g., an environmentally neutral glue), or another manner of attachment. In some embodiments, the annular disposition of the elongated inner tubular weighted mass within the casing shell may be removable. For example, the removal of the casing shell can allow for the use of a replacement casing shell with the elongated inner tubular weighted mass. In some embodiments, the casing shell may be formed around the elongated inner tubular weighted mass such that the elongated inner tubular weighted mass is substantially or wholly encased within the casing shell.

The shape of the casing shell and/or the shape of the elongated inner tubular weighted mass can be variable based on aspects of the fishing activity, for example, desired casting distance, fishing line diameter, fishing conditions, or the like, or a combination thereof. The smooth, rounded shape and buoyancy of the casing shell allow the slip sinker to immediately begin rising from the bottom of the body of water, such as to mitigate tangling in weeds or other obstructions. The soft material of the casing shell causes the slip sinker to make less noise than a conventional sinker, such as when making contact with hard objects (e.g., rocks) on the bottom of a body of water.

Thus, the embodiments of the slip sinker disclosed herein have several benefits over conventional sinkers. For example, the disclosed slip sinker has a slower sink rate as it sinks to the bottom of a body of water. In another example, the disclosed slip sinker lands with less noise so as to not disturb or frighten fish. In yet another example, the slower sink rate and relatively large size of the soft casing shell prevent the slip sinker from digging into or otherwise become buried in the soft bottom of the body of water. In yet another example, the disclosed slip sinker has an improved casting feature in that the combination of materials comprising the disclosed slip sinker allow the disclosed slip sinker to be cast farther and with greater ease and precision than a conventional sinker. In yet another example, the disclosed slip sinker has an outer casing shell with high durability, which prevents it from breaking when coming into contact with hard rocks or like surfaces.

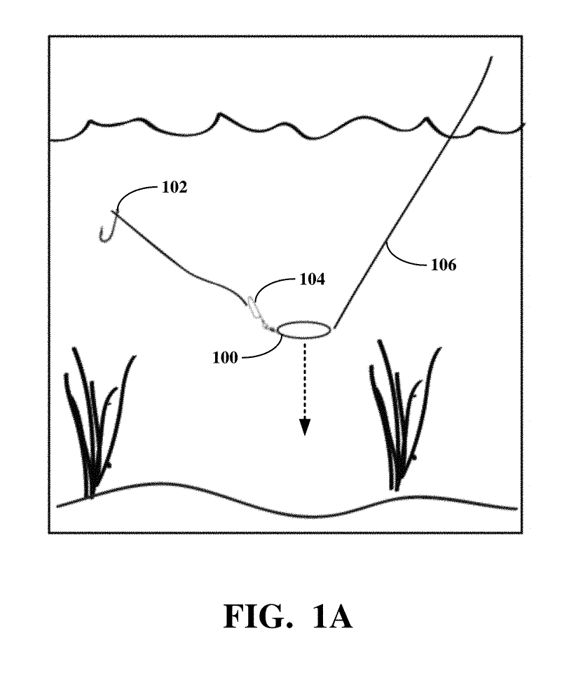

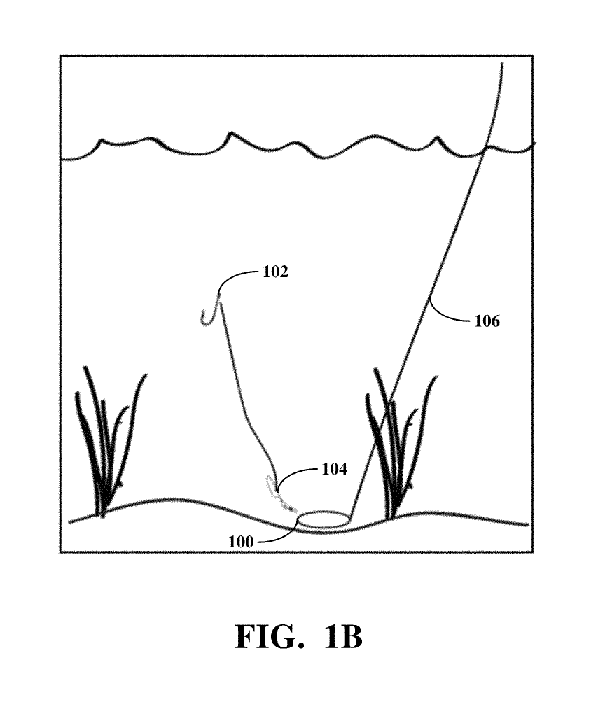

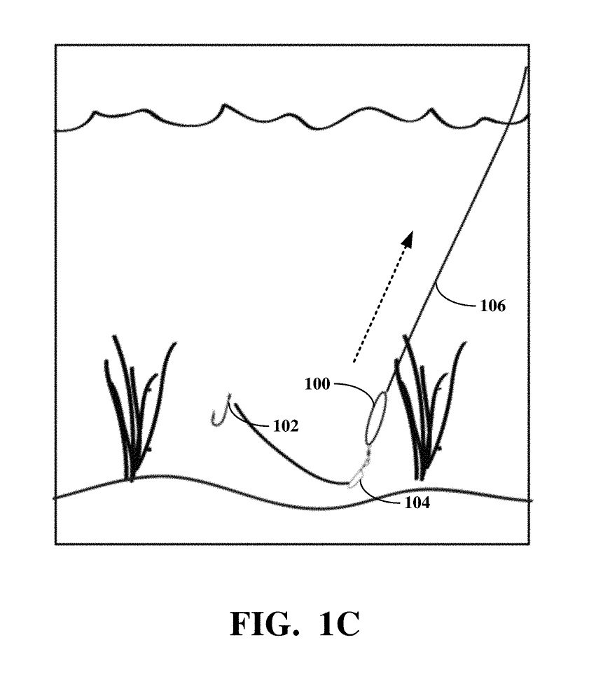

FIGS. 1A-C are illustrations showing examples of the use of a slip sinker 100, which is a slip sinker according to the embodiments of this disclosure. The slip sinker 100 is part of a fishing assembly that also includes a hook 102, a swivel 104, and a line 106. FIGS. 1A-C depict different stages of the use of the slip sinker 100 in connection with the rest of the fishing assembly. In FIG. 1A, the slip sinker 100 causes a slowed sinking of the slip sinker 100 to and a softened landing of the slip sinker 100 at a bottom of the body of water. In FIG. 1B, the slip sinker 100 remains along the bottom of the body of water while the user of the fishing assembly pursues a fish. In FIG. 1C, the slip sinker 100 causes an accelerated rising to the surface of the water, such as responsive to a tugging or reeling of the line 106.

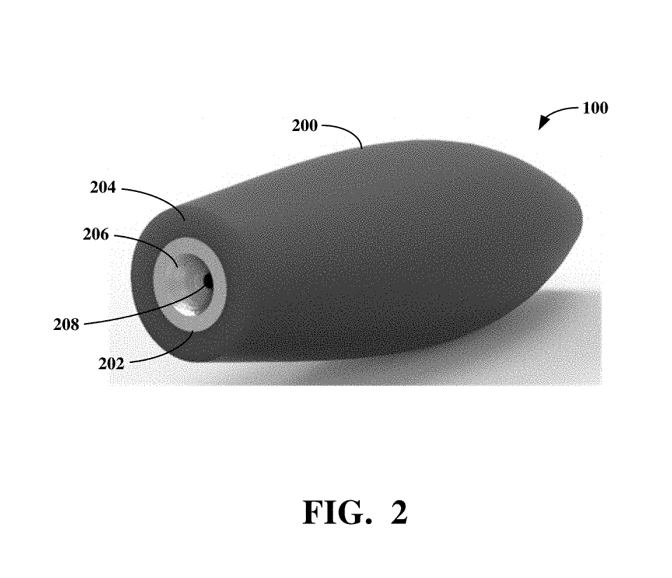

FIG. 2 is an illustration of showing a first example view of the referenced slip sinker 100. For example, the first view may be a front perspective view of the slip sinker 100. The slip sinker 100 includes a casing shell 200, which is a casing shell according to the embodiments of this disclosure, and an elongated inner tubular weighted mass 202, which is an elongated inner tubular weighted mass according to the embodiments of this disclosure.

The casing shell 200 has a first end 204. The elongated inner tubular weighted mass 202 has a first end 206. The first end 206 of the elongated inner tubular weighted mass 202 is generally concave relative to the first end 204 of the casing shell 200. An opening 208 runs through the center of the elongated inner tubular weighted mass 202. The opening 208 is configured to slidably and easily receive a fishing line. The concave shape of the first end 206 of the elongated inner tubular weighted mass 202 allows for an easy threading of the fishing line through the opening 208.

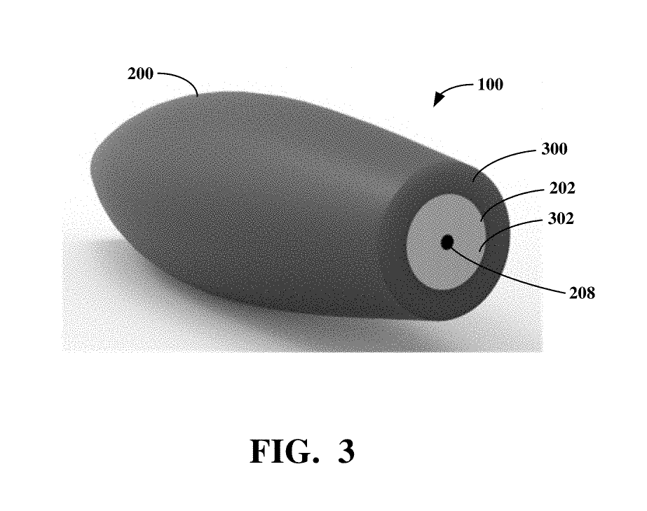

FIG. 3 is an illustration of showing a second example view of the referenced slip sinker 100. For example, the second view may be a rear perspective view of the slip sinker 100. The casing shell 200 has a second end 300. The elongated inner tubular weighted mass 202 has a second end 302. The second end 302 of the elongated inner tubular weighted mass 202 is generally convex relative to the second end 300 of the casing shell 200. A fishing line slidably received within the opening 208 enters through the opening at the first end of the elongated inner tubular weighted mass 202 and exits through the opening at the second end 302 of the elongated inner tubular weighted mass 202.

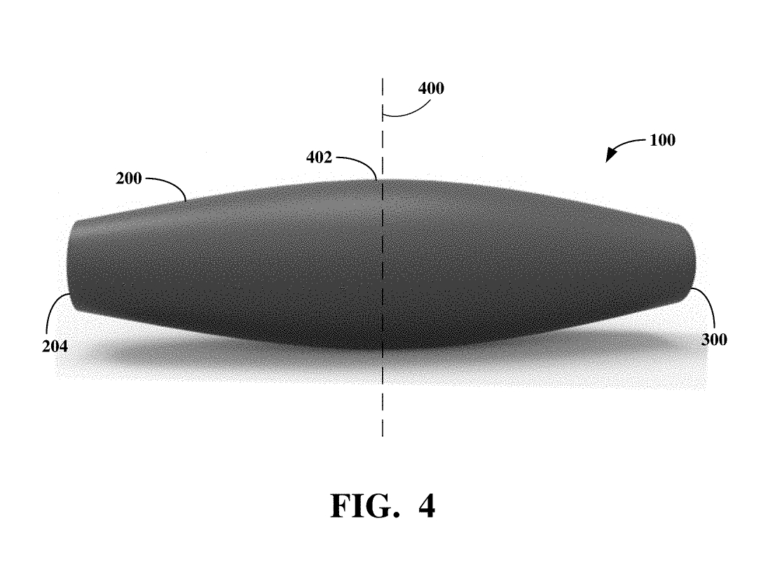

FIG. 4 is an illustration of showing a third example view of the referenced slip sinker 100. For example, the third view may be a side view of the slip sinker 100. An axial plane 400 is shown about a central portion 402 of the slip sinker 100. As is shown, the casing shell 200 features a circumferential bulge at the central portion 402 along the axial plane 400. The circumferential bulge is defined by a symmetrical and gradual radial increase of a cross-section of the casing shell 200 between the central portion 402 and each of the first end 204 and the second end 300 of the casing shell 200. Thus, a cross-section at either of the first end 204 or the second end 300 of the casing shell 200 is smaller than a cross-section at the central portion 402. The exterior surface of the casing shell 200 is smooth. The smooth exterior surface and the gradual radial increase of the casing shell 200 mitigate obstructions from catching the slip sinker 100 during use.

As shown, the casing shell 200 is oblong. However, in some implementations, alternative designs may be used. For example, the casing shell 200 may have a more egg-shaped appearance. In another example, the casing shell 200 may have a more torpedo-shaped appearance. The particular shape of an embodiment of the casing shell 200 may be selected based on the types of fish being pursued by a user, by the conditions in the area being fished, or the like, or a combination thereof. In some embodiments in which the annular disposition of the elongated inner tubular weighted mass (not shown) within the casing shell 200 is removable, a first casing shell (e.g., the casing shell 200) having a first shape may be removed to allow for a second casing shell having a second shape different from the first shape to be used.

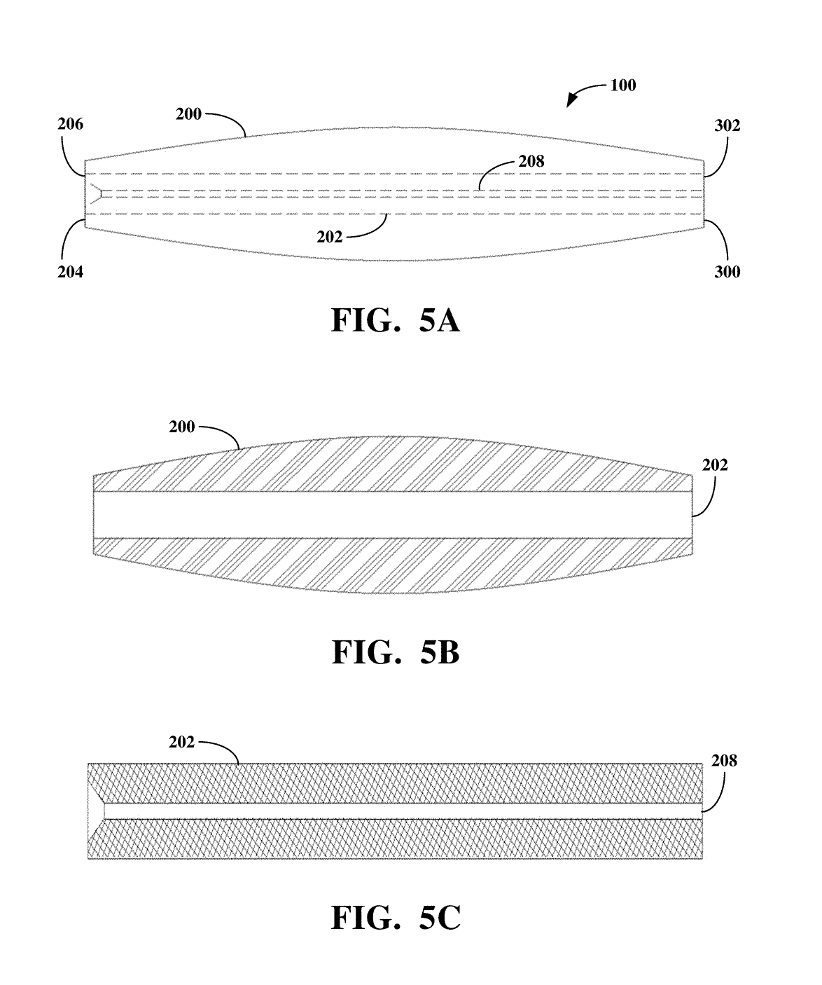

FIGS. 5A-C are illustrations showing examples of internal structures of the referenced slip sinker, such as the slip sinker 100. FIGS. 5A-C depict different structures of the slip sinker 100. In FIG. 5A, the casing shell 200, the elongated inner tubular weighted mass 202, and the opening 208 through the center of the elongated inner tubular weighted mass 202 are shown. As earlier described, the first end 206 and the second end 302 of the elongated inner tubular weighted mass 202 are beveled with respect to the first end 204 and the second end 300 of the casing shell 200. For example, the first end 206 of the elongated inner tubular weighted mass 202 may be generally concave relative to the first end 204 of the casing shell 200 and the second end 302 of the elongated inner tubular weighted mass 202 may be generally convex relative to the second end 300 of the casing shell 200.

In FIG. 5B, the casing shell 200 and the elongated inner tubular weighted mass 202 are shown. In particular, the solid volume of the casing shell 200 surrounding the outer surface of the elongated inner tubular weighted mass 202 is shown. The casing shell 200 is comprised of a buoyant material. The buoyant material may be a synthetic material, a naturally occurring material, or a combination thereof. In FIG. 5C, the elongated inner tubular weighted mass 202 and the opening 208 are shown. In particular, the solid volume of the elongated inner tubular weighted mass 202 surrounding the opening 208 is shown. The elongated inner tubular weighted mass 202 is comprised of metal or other weighted material or materials.

While this disclosure has been described in connection with certain embodiments, it is to be understood that this disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A slip sinker, comprising:
a casing shell comprised of a buoyant material, the casing shell featuring a circumferential bulge at a central portion along an axial plane; and
an elongated inner tubular weighted mass annularly disposed within the casing shell, the elongated inner tubular weighted mass including an opening configured to slidably receive a fishing line,
wherein a first end of the elongated inner tubular weighted mass is generally concave relative to a first end of the casing shell and a second end of the elongated inner tubular weighted mass is generally convex relative to a second end of the casing shell, and
wherein the circumferential bulge is defined by a symmetrical and gradual radial increase of a cross-section of the casing shell between the central portion of the casing shell and each of the first end of the casing shell and the second end of the casing shell.

2. The slip sinker of claim 1, wherein the buoyant material of the casing shell causes a slowed sinking rate and an accelerated rising rate for the slip sinker.

3. The slip sinker of claim 1, wherein an exterior surface of the casing shell is smooth, wherein the smooth exterior surface and the gradual radial increase of the casing shell mitigate obstructions from catching the slip sinker during use.

4. The slip sinker of claim 1, wherein the annular disposition of the elongated inner tubular weighted mass within the casing shell is removable, wherein removal of the casing shell allows for use of a replacement casing shell with the elongated inner tubular weighted mass.

5. The slip sinker of claim 1, wherein the buoyant material of the casing shell is one of foam, Styrofoam, ethylene-vinyl acetate, expanded polystyrene, or another synthetic material.

6. The slip sinker of claim 1, the buoyant material of the casing shell is one of bamboo, wood, or another naturally occurring material.

7. The slip sinker of claim 1, wherein the elongated inner tubular weighted mass is comprised of one of lead, tungsten, or another material having a higher density than the buoyant material of the casing shell.

8. The slip sinker of claim 1, wherein the casing shell is oblong, round, square, or rectangular.

9. A slip sinker, comprising:
a casing shell comprised of a buoyant material, the casing shell featuring a circumferential bulge at a central portion along an axial plane; and
an elongated inner tubular weighted mass annularly disposed within the casing shell, the elongated inner tubular weighted mass including an opening configured to slidably receive a fishing line,
wherein the buoyant material of the casing shell causes a slowed sinking rate and an accelerated rising rate for the slip sinker.

10. The slip sinker of claim 9, wherein a first end of the elongated inner tubular weighted mass is generally concave relative to a first end of the casing shell and a second end of the elongated inner tubular weighted mass is generally convex relative to a second end of the casing shell.

11. The slip sinker of claim 10, wherein the circumferential bulge is defined by a symmetrical and gradual radial increase of a cross-section of the casing shell between the central portion of the casing shell and each of the first end of the casing shell and the second end of the casing shell.

12. The slip sinker of claim 11, wherein an exterior surface of the casing shell is smooth, wherein the smooth exterior surface and the gradual radial increase of the casing shell mitigate obstructions from catching the slip sinker during use.

13. The slip sinker of claim 9, wherein the annular disposition of the elongated inner tubular weighted mass within the casing shell is removable, wherein removal of the casing shell allows for use of a replacement casing shell with the elongated inner tubular weighted mass.

14. The slip sinker of claim 9, wherein the buoyant material of the casing shell is a synthetic material.

15. The slip sinker of claim 14, wherein the synthetic material is one of foam, Styrofoam, ethylene-vinyl acetate, or expanded polystyrene.

16. The slip sinker of claim 9, wherein the buoyant material of the casing shell is a naturally occurring material.

17. The slip sinker of claim 16, wherein the naturally occurring material is one of bamboo or wood.

18. The slip sinker of claim 9, wherein the elongated inner tubular weighted mass is comprised of one of lead, tungsten, or another material having a higher density than the buoyant material of the casing shell.

19. The slip sinker of claim 9, wherein the casing shell is oblong, round, square, or rectangular.

20. A slip sinker, comprising:
a casing shell comprised of a buoyant material, the casing shell featuring a circumferential bulge at a central portion along an axial plane; and
an elongated inner tubular weighted mass annularly disposed within the casing shell, the elongated inner tubular weighted mass including an opening that slidably receives a fishing line between a first end of the fishing line and a second end of the fishing line,
wherein a first end of the elongated inner tubular weighted mass is generally concave relative to a first end of the casing shell and a second end of the elongated inner tubular weighted mass is generally convex relative to a second end of the casing shell,
wherein the slidable receipt of the fishing line within the opening of the elongated inner tubular weighted mass causes the slip sinker to slidably move along the fishing line between the first end of the fishing line and the second end of the fishing line during use,
wherein the circumferential bulge is defined by a symmetrical and gradual radial increase of a cross-section of the casing shell between the central portion of the casing shell and each of the first end of the casing shell and the second end of the casing shell,
wherein the buoyant material of the casing shell causes a slowed sinking rate and an accelerated rising rate for the slip sinker, and
wherein an exterior surface of the casing shell is smooth, wherein the smooth exterior surface and the gradual radial increase of the casing shell mitigate obstructions from catching the slip sinker during use.
